(19) United States
(12) Patent Application Publication
(10) Pub. No.: US 2006/0059088 A1
(43) Pub. Date: Mar. 16, 2006

(54) Method and system for purchase card utilization and data reconciliation with enterprise resource planning/financial software

(76) Inventors: Shari Krikorian, Armonk, NY (US); Alicia Cavallaro, Milford, CT (US)

Correspondence Address: BAKER & BOTTS, 30 ROCKEFELLER PLAZA, NEW YORK, NY, 10112, US

(21) Appl. No.: 11/197,231

(22) Filed: Aug. 4, 2005

Related U.S. Application Data
(60) Provisional application No. 60/598,811, filed on Aug. 4, 2004.

(51) Int. Cl. G06Q 40/00

(52) U.S. Cl. 705/40

(57) ABSTRACT

The present invention provides a system and method for using an organization's existing ERP to perform automated reconciliation of purchasing card transactions. A buyer receives invoices from a supplier requesting payment for goods or services. The buyer's ERP validates the invoice using, for example, a three-way match process. After three-way validation, and once the invoices come due, the buyer's ERP sends the supplier an e-mail remittance advice. This remittance advice includes the buyer's partially masked purchasing card details, and a unique payment number that was previously generated by the buyer's ERP, and that is associated with a corresponding open purchase order. The supplier submits a payment authorization request to a POS device by inputing the partially masked purchasing card details and the unique payment number from the buyer ERP's e-mailed remittance advice. The payment network processes the supplier's payment request in accordance with conventional payment network authorization procedures. Periodically the buyer's ERP receives purchasing card transaction data from the purchasing card issuer. The purchasing card transaction data details the buyer's purchasing card transactions for the preceding period. The purchasing card transaction details include the unique payment number that was generated by the buyer's ERP, and that was inputted to the POS by the supplier during the payment authorization process. The buyer's ERP may use the unique payment number to match the purchasing card transaction back to a corresponding open purchase order.

### CROSS-REFERENCE TO RELATED APPLICATION

This application claims priority to a U.S. Provisional Application entitled “Method and System for Purchase Card Utilization and Data Reconciliation with Enterprise Resource Planning/Financial Software,” Ser. No. 60/598,811, which was filed on Aug. 4, 2004, and is incorporated by reference into the present application.

### BACKGROUND OF INVENTION

Conventionally, businesses and other organizations have used paper-based processes to track the invoicing of, and payment for, goods or services. In a typical paper-based process, supplier organization prepares a paper invoice and mails it to a buyer organization, which has purchased a particular good or service from the supplier. The supplier's paper invoice details the goods or services that the supplier has provided, and the amount of money that the supplier is owed.

On receiving the paper invoice, the buyer typically uses what is known as a “three-way match” process to verify the accuracy of the invoice. In the three-way match process, the buyer matches the paper invoice against two other paper documents that the buyer generates during the process of ordering goods or services: (i) a purchase order, which is generated at the time the order for goods or services is placed, and (ii) a receiver document, which is generated once the goods or services have been received. Upon completing the three-way match and thereby verifying the supplier's invoice, the buyer sends payment to the supplier, usually in the form of a paper check through the mail. Finally, after mailing payment, the buyer reconciles the payment to the supplier with its accounting books, using information contained in the invoice, purchase order, and/or receiver documents.

Known systems exist for automating the above-described procurement and reconciliation processes. These known systems, however, have not typically allowed for utilization of purchasing cards (such as credit cards, debit cards, corporate cards, and purchasing cards) as a means of business-to-business payment. As a result, existing systems are not capable of integrating data about business-to-business purchasing card transactions with an organization's internal business management software, such as its enterprise resource planning (“ERP”) system.

As a consequence, the purchasing card reconciliation process in known systems typically requires that invoice data be manually re-keyed, matched with the purchasing card transaction data, and then manually re-entered into the organization's ERP system—a process that is both time consuming and error prone. Moreover, automating this purchasing card reconciliation process in known systems typically requires the organization to create customized software, a process which is complicated, disruptive, and costly.

There exists a need in the art for a simplified method for automating the reconciliation of purchasing card data in business-to-business transactions that avoids complicated and costly software customizations.

### SUMMARY OF THE INVENTION

The present invention provides a system and method for using an organization's existing ERP to perform automated reconciliation of purchasing card transactions. In accordance with any exemplary embodiment of the present invention, a buyer 110 receives invoices from a supplier 120 requesting payment for goods or services. The buyer's ERP 110a validates the invoice using, for example, a three-way match process. After three-way validation, and once the invoices come due, the buyer's ERP 110a sends the supplier 120 an e-mail remittance advice. This remittance advice includes the buyer's 110 partially masked purchasing card details, and a unique payment number that was previously generated by the buyer's ERP 110a, and that is associated with a corresponding open purchase order.

The supplier 120 submits a payment request to a payment network 150 by inputting into a POS device 130 the partially masked purchasing card details and the unique payment number from the buyer ERP's 110a e-mailed remittance advice. The payment network 150 processes the supplier's 120 payment request in accordance with conventional payment network authorization procedures.

Periodically, and preferably monthly, the buyer's ERP 110a receives purchasing card transaction data from the purchasing card issuer 160. The purchasing card transaction data details the buyer's 110 purchasing card transactions for the preceding period. In accordance with an embodiment of the present invention, the purchasing card transaction details include the unique payment number that was generated by the buyer's ERP 110a, and that was inputted to the POS by the supplier during the payment authorization process. The buyer's ERP 110a may use the unique payment number to match the purchasing card transaction back to a corresponding open purchase order.

Thus, the present invention includes a novel business process that supports (i) a three-way match process before purchasing card payment takes place and (ii) automated reconciliation of those purchasing card transactions at the end of the cycle.

### BRIEF DESCRIPTION OF THE DRAWINGS

FIG. 1 is a block diagram depicting a system for reconciling purchasing card transactions, in accordance with an exemplary embodiment of the present invention;

FIG. 2 is a flowchart showing an exemplary method for conducting a purchasing card procurement transaction without a purchase order;

FIG. 3 is a flowchart showing an exemplary method of setting up a buyer organization's electronic procurement/ERP system;

FIG. 4 is a flowchart showing an exemplary method of reconciling purchasing card procurement transactions without a purchase order;

FIG. 5 depicts a credit card transactions window, in accordance with an exemplary embodiment of the present invention;

FIG. 6 depicts a credit card transaction distributions window, in accordance with an exemplary embodiment of the present invention;

FIG. 7 is a flowchart showing an exemplary method for conducting a purchasing card procurement transaction with a purchase order; and

FIG. 8 is a flowchart showing an exemplary method of reconciling purchasing card procurement transactions with a purchase order.

### DETAILED DESCRIPTION OF THE INVENTION

As a preliminary matter, the following terms are defined for purposes of clarifying the description that follows:

(a) FTP—File Transfer Protocol
Protocol that allows users to copy files between their local system and any system they can reach on the network.

(b) General Ledger (GL)
The ledger that contains all of the financial accounts of a business.

(c) MasterCard Global Data Repository
The MasterCard Corporate Products data repository receives data from issuer and/or acquirer banks and/or processors, and determines which downstream application(s) to send the data to. Currently, the MasterCard Global data repository sends data to the Smart Data OnLine, Smart Data File Express and Smart Data OnLine applications, as well as numerous other third-party applications.

(d) Merchant Category Codes (MCC)
Four-digit classification codes used in authorization, clearing, and other transactions or reports to identify the type of merchant.

(e) Enterprise Resource Planning (ERP) System
ERP is an industry term for the broad set of activities supported by multi-module application software that help a manufacturer or other business manage the important parts of its business, including product planning, parts purchasing, maintaining inventories, interacting with suppliers, providing customer service, and tracking orders. ERP can also include application modules for the finance and human resources aspects of a business. Typically, an ERP system uses or is integrated with a relational database system.

(g) Purchasing Cards
Purchasing cards (such as MasterCard's P-Cards) are a type of commercial card that buyer organizations can use to simplify procurement transactions. Increasingly, organizations are using them for larger ticket items like capital goods. Purchasing cards are convenient because they have roughly the same capabilities as credit cards, address procurement, payment and reconciliation processes, and provide an end-to-end solution for data capture and reporting. Ultimately, purchasing cards increase employees' purchasing flexibility while allowing the buyer organization to maintain tight control over its spending.

(h) POS
Point of sale system. An electronic system that accepts financial data at or near a retail selling location and transmits that data to a computer or authorization network for reporting activity, authorization, and transaction logging.

(i) Prepayment Invoice
Payment in advance for an itemized statement of money owed for goods shipped or services rendered.

(j) Smart Data OnLine (SDOL)
MasterCard Smart Data OnLine™ is a global Web-based reporting application that helps companies seamlessly organize, consolidate, analyze and manage financial data from cards, cash transactions and other MasterCard programs.

(k) SQLLoader
SQL*Loader is a bulk loader utility used for moving data from external files into the ERP database. SQL*Loader supports various load formats, selective loading, and multi-table loads.

By way of background, MasterCard's purchasing card (i.e., “P-Card”) was first introduced in 1993 to provide organizations with an improved means for expense management. Key benefits of the P-Card are that it 1) provides convenience, 2) reduces paperwork, 3) allows management to exert greater control through the card's authorization system, 4) is accepted by merchants worldwide as a form of payment according to rules established by certain card associations, and 5) provides reporting back to the organization about the card transactions.

Typically there are three different types of transaction data that may be reported to a purchasing cardholder. “Level I” data includes only the information that appears on a standard credit card statement, such as the transaction amount, transaction date, merchant name, and city/state of the merchant. “Level II” data includes buyer information, tax amount, the supplier organization's ZIP code, and the supplier organization's tax identification information. “Level III” purchasing card data is the most detailed transaction data available, and includes detail on each line item in a purchase, such as item description, product codes, quantity, unit-of-measure, price, delivery zip codes, freight charges, and sales tax information. Level III data is valuable for purchasing organizations, as it can be useful for streamlining the accounting processes and easily merging purchase data with their internal electronic procurement files.

Although Level III data may be very useful to organizations for reconciliation purposes, unfortunately it is not available a majority of the time because the transmission of Level III data requires the supplier and supplier's acquirer or processor to be set up to handle Level III data. While some supplying organizations and their acquirers or processors have the capability to provide level III data, most do not.

Even assuming that Level III data is reported to the buying organization, however, there exists no system for automated integration of Level III P-Card data into an organization's internal systems such as its Enterprise Resource Planning (“ERP”) system or Accounts Payable (“A/P”) system. Accordingly, organizations are forced to manually re-key invoice data, match it with the card transaction for reconciliation purposes, and then manually enter the data into the organization's ERP or A/P system.

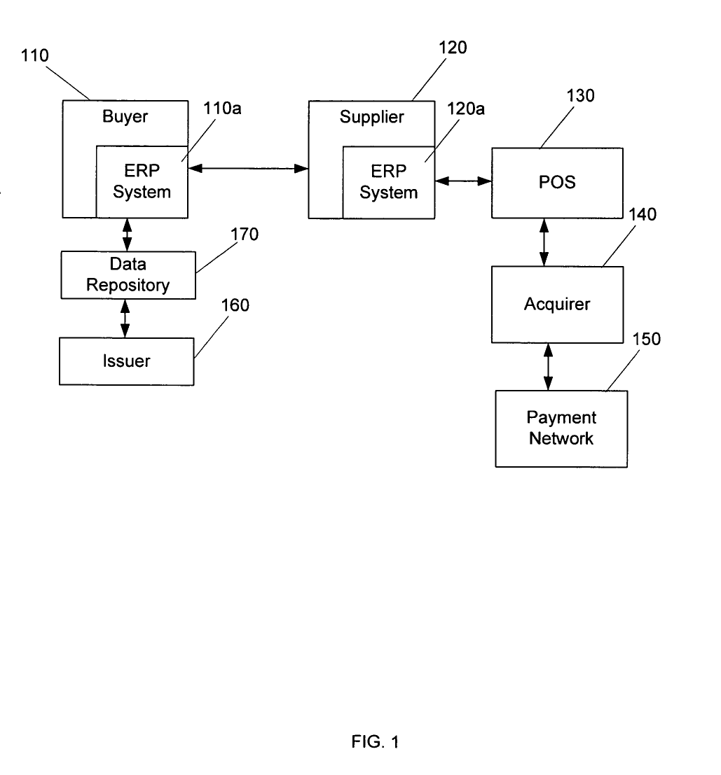

FIG. 1 is a block diagram depicting the components of a system for processing and reconciling purchasing card procurement transactions, in accordance with an exemplary embodiment of the present invention. The system includes the buyer 110, the buyer's ERP system 110a, a supplier 120, and the supplier's ERP system 120a. The supplier's ERP system 120a may be coupled to the supplier's 120 purchasing card acquirer bank or processor 140 through, for example, a POS terminal 130. The acquirer 140 may be coupled to a payment network 150 such as, for example, the MasterCard payment network. The buyer's ERP system 110a may be coupled to a data repository 170, such as, for example, the MasterCard Global Data Repository. The data repository 170 receives purchasing card transaction data from the buyer's issuer bank or processor 160.

Exemplary Process of P-Card Reconciliation Without Purchase Order

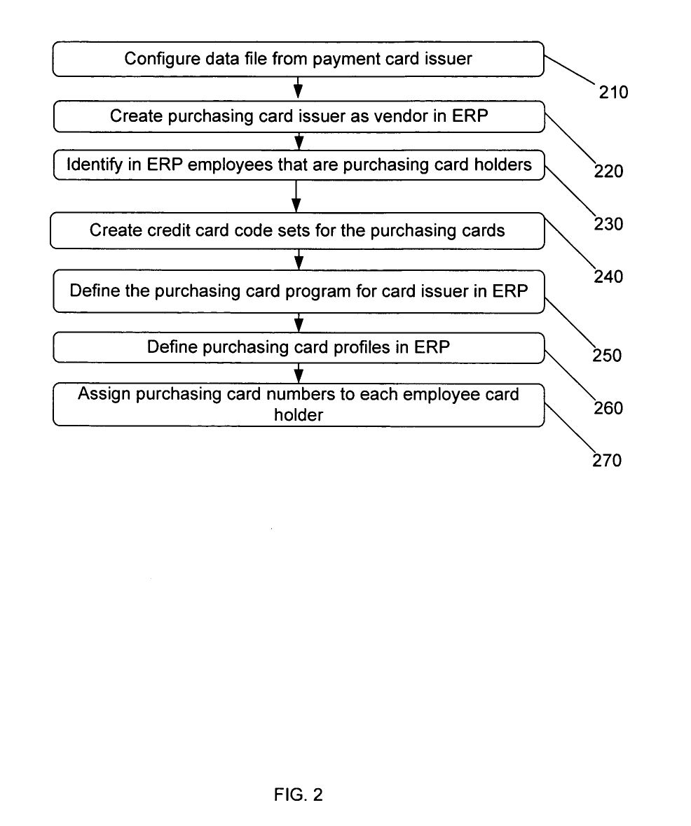

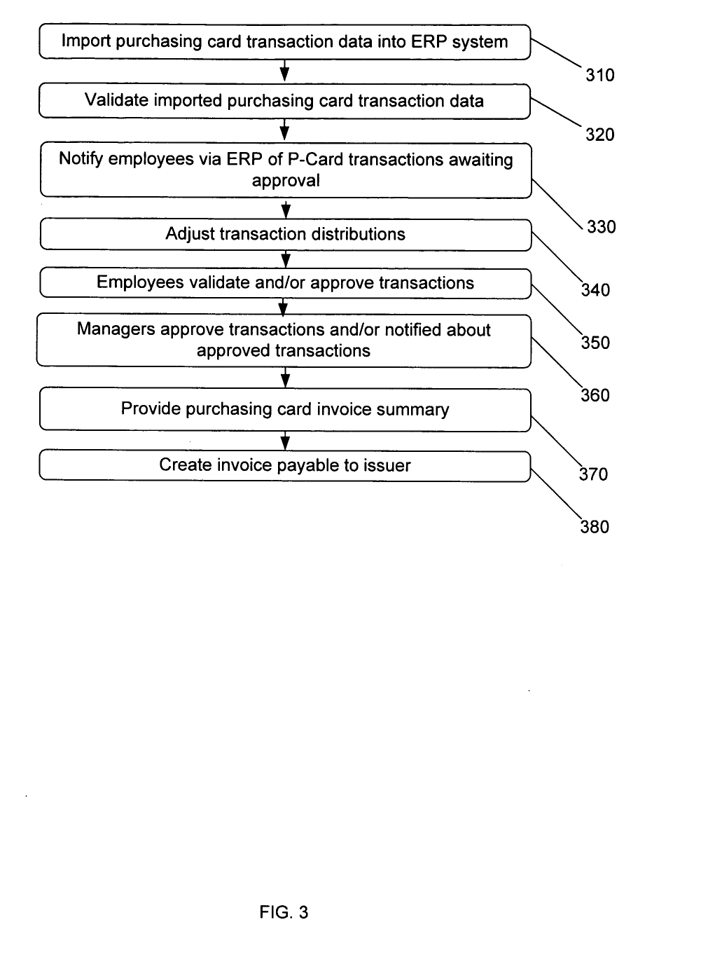

FIG. 2 is a flowchart of the preliminary steps that must be taken to set up the buyer's ERP system 110a before automated purchasing card reconciliation may be performed in accordance with an exemplary embodiment of the present invention. Referring to both FIGS. 1 and 2, at step 210, the first item to be configured in the buyer's ERP system 110a is a data file to receive data from the purchasing card issuer 160 via, for example, a data repository 170. The data file in the buyer's ERP 110a may be configured to receive data from the issuer 160 using any variety of standards, such as, for example, Smart Data for Windows®, MasterCard Global Data Repository, etc. The data file preferably stores the transaction details from the issuer 160 necessary for the buyer's ERP 110a to automatically reconcile purchasing card transactions, including, for example, the buyer's 110 purchasing card number, the date of each transaction, a unique payment number that was previously generated by the buyer's ERP 110a for each transaction, and the amount of each transaction.

At step 220, the purchasing card issuer 160 is preferably created as a vendor in the buyer's ERP system 110a, and the supplier 120 site is preferably defined. At step 230, information is preferably entered into the buyer's ERP 110a identifying which of the buyer's 110 employees are purchasing card holders. The information entered about the purchasing card holding employees preferably includes the employee's name, his/her supervisor's name, his/her home and office address, a default expense account number for the employee, and cost center information.

At step 240, credit card code sets for the buyer's 110 purchasing cards are preferably created in the buyer's ERP 110a. The credit card code sets are used by the buyer ERP 110a to create default accounting distributions for transactions that are imported from the purchasing card issuer 160. Generally, the purchasing card issuer maintains card codes, such as MCC codes, to identify vendors and vendor types for the transactions that employees incur when using a purchasing card.

At step 250, the buyer 110 preferably defines in the buyer's ERP 110a a purchasing card program for the issuer 160. This may be accomplished, for example, by selecting the vendor and vendor site, as defined in step 220, for the purchasing card program. Additionally, at step 250, the buyer 110 may also specify which transaction statuses to exclude when automatically creating an invoice for the purchasing card issuer 160, such as, for example, “disputed,” “unverified,” etc.

At step 260, the buyer 110 preferably defines in the buyer's ERP 110a credit card profiles for the buyer's 110 purchasing cards. The credit card profiles enable the buyer 110 to define various types and levels of spending that the buyer 110 will permit for the buyer's purchasing card holders. A credit card profile is preferably assigned to each purchasing card that is assigned to a purchasing card holder. The buyer 110 can specify the level of employee verification and manager approval required for each employee purchasing card to which a profile is assigned. Optionally, default general ledger codes or templates may be defined and assigned to a purchasing card profile.

At step 270, the buyer 110 preferably assigns in the buyer's ERP 110a a purchasing card account number to each of the buyer's 110 purchasing card holders. All purchasing cards distributed to the buyer's 110 employees must be defined and assigned to the buyer's 110 employees via this setup step 270. This step 270 links all previous steps in FIG. 200 together.

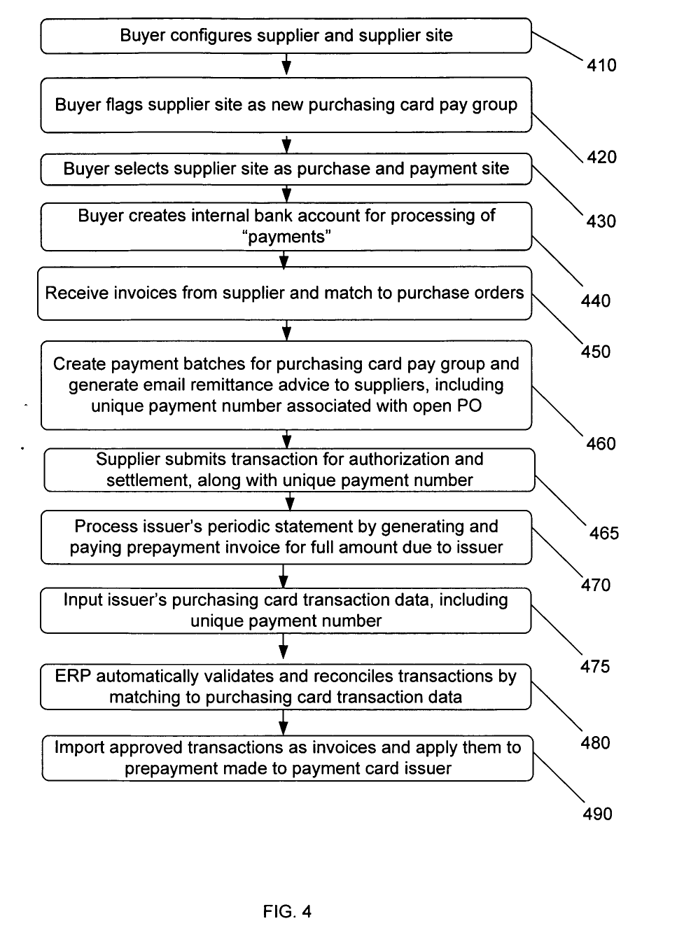

FIG. 4 is a flowchart depicting the reconciliation process for purchasing card transactions that are not initiated by purchase order, in accordance with an exemplary embodiment of the present invention. At step 410, the purchasing card transaction data is imported into the buyer's ERP system 110a, preferably from the data repository 170. In an exemplary embodiment, the purchasing card transaction data is exported from the data repository 170 in a text file format, and the test file is sent via FTP to the data file configured in buyer's ERP system 110a at step 210 (FIG. 2). The data file is then loaded by a customized SQL Loader program into a database table in the buyer's ERP system 110a, such as, for example, an AP_EXPENSE_FEED_LINES_ALL table.

At step 320, a validation program may then be run in the buyer's ERP system 110a to validate the purchasing card transaction data. The validation program is preferably used to validate the imported credit card number data, and to create account distributions based on the purchasing card holding employee profiles stored in the buyer's ERP 110a.

At step 330, the buyer's 110 employees may be notified by the buyer's ERP 110a that there exist purchasing card transactions that are awaiting approval. This buyer's ERP 110a associates the purchasing card transactions with the appropriate respective employee based on the previously defined setup data (see FIG. 2).

At step 340, transaction distributions may be adjusted or split by the buyer's 110 purchasing card holding employees into multiple accounting distributions using the buyer's ERP 110a. When transaction data is initially loaded, each transaction has one accounting distribution based on the employee default field assignment as derived via the human resources employee tables, stored in the buyer's ERP 110a.

At step 350, the buyers' 110 employees may validate and/or approve his or her purchasing card transactions. In an exemplary embodiment of the present invention, a buyer 110 may require justification from its employees for each purchasing card transaction. This justification information may be entered into the buyer's ERP 110a via a descriptive field, preferably before employees may approve transactions. After completing all validation or approval tasks within the buyer's ERP 110a, each the buyer's 110 purchasing card holding employees may print a custom report showing purchasing card transactions for a given time period, for example, a given month. The custom report may be used to provide the buyer's 110 employees a report view of their data, and the buyer's 110 employees may submit a the custom report to their managers for approval. Once approved by the manager, the report may be submitted to accounts payable along with corresponding receipts.

At step 360, managers may approve transactions and/or be notified about approved transactions. In an exemplary embodiment of the present invention, after the buyer's 110 employees have either verified their transactions or received a notification that transactions have been posted to their account, another workflow process may be initiated and executed as defined by the buyer's ERP 110a. If desired by the buyer 110, a manager may approve an employee's transactions directly from an ERP 110a workflow notification. Alternatively, a manager may simply receive a notification that lists all purchasing card transactions incurred by the manager's direct reports. Once this process is complete and the appropriate manager action taken, the purchasing card transactions are ready to be included on an invoice.

At step 370, a purchasing card invoice interface summary is provided. In accordance with an exemplary embodiment of the present invention, the buyer's ERP 110a takes data about the purchasing card transactions and uses it to populate the ERP's 110a open accounts payable interface tables. As part of this process, the buyer's 110 purchasing card transactions may be summarized within the buyer's ERP 110a by GL account distribution. Alternatively, a distribution line for each transaction will be created in the buyer's ERP 110a. Preferably, records are selected that, at a minimum, have been validated by the buyer's 110 employees.

At step 380, the buyer's ERP 110a creates an invoice that is payable to the issuer 160. In an exemplary embodiment of the present invention, if the employee has not summarized the transactions, each transaction becomes a distribution line on the invoice. If the transactions were summarized, a distribution line for each GL account code combination is preferably created.

Exemplary Process of P-Card Reconciliation With Purchase Order

So far, what has been described is an exemplary embodiment of the present invention in which a buyer's 110 purchasing card transactions may be reconciled without an initial purchase order. Many organizations today, however, require that all purchases be initiated with a purchase order, and the receipt back of an invoice, before payment may be approved. Accordingly, an exemplary process will now be described by which purchasing card transactions that are initiated with a purchase order may be automatically reconciled within a buyer's ERP system 110a.

The purchase order driven approach of the present invention specifically preserves the standard process controls within the buyer's ERP 110a of on-line matching of invoices to purchase orders. This ensures that the price and quantity tolerances are not exceeded and that the proper approvals are in place for the order before payment occurs. And since most buyer organizations require a “three-way” match—purchase order to invoice to receipt of goods—this approach also validates that the goods or services have been received before payment processing takes place.

In accordance with an exemplary embodiment of the present invention, when an invoice from a supplier 120 is due to be paid (based on the terms defined in the contract between the buyer and supplier), the buyer's ERP 110a generates a remittance advice that is e-mailed to the supplier 120. The remittance advice may include, for example, partially masked card details (ghost accounts) and a unique payment number generated by the buyer's ERP 110a that is associated with an open purchase order. When the supplier 120 submits an authorization request for payment of its invoice via a POS terminal 130, the supplier 120 inputs the partially masked card details and the unique payment number provided in the remittance advice when prompted by the POS terminal 130. The supplier 120 may enter the unique payment number, for example, in the customer code field when prompted for it by the POS 130.

Periodically, and preferably monthly, the buyer's ERP 110a receives purchasing card transaction data from the purchasing card issuer 160. The purchasing card transaction data details the buyer's 110 purchasing card transactions for the preceding period. In accordance with an embodiment of the present invention, the purchasing card transaction details include the unique payment number that was generated by the buyer's ERP 110a, and that was inputted to the POS by the supplier during the payment authorization process. The buyer's ERP 110a may use the unique payment number to match the purchasing card transaction back to a corresponding open purchase order.

FIG. 4 is a flowchart depicting an exemplary process for using the buyer's ERP 110a to automatically reconcile purchasing card transactions initiated by purchase order. At step 410, the buyer's ERP 110a is preferably configured to recognize the supplier and supplier site. In an exemplary embodiment of the present invention, a descriptive field, such as a field in the buyer ERP's 110a credit card transaction form, may be modified to store the identity of the supplier and the supplier site.

At step 420, the supplier site entry in the buyer's ERP 110a, which was created at step 410, preferably flags a new purchasing card pay group, defined, for example, as “P-Card.” At step 430, the buyer 110 preferably selects the supplier 120, as defined in the buyer's ERP 110a, as both a purchase and payment site, but preferably not as a purchasing card site.

At step 440, an internal bank account is preferably set up specifically for the processing these purchasing card “payments.” This internal bank account is preferably not posted to a cash account, but rather, for example, to a purchasing card clearing account, so that the internal “payments” will be offset when the purchasing card transaction data is loaded from the data repository 170 into the buyer's ERP 110a at, for example, month's end.

At step 450, the buyer 110 may receive an invoice, whether paper or electronic, from the supplier 120. The buyer's ERP 110a matches those invoices to purchase orders. In an exemplary embodiment of the present invention, the supplier's 120 invoices should reflect the purchasing card as the pay group within the buyers ERP 110a.

At step 460, the buyer's ERP 110a creates payment batches for the purchasing card pay group, which triggers the generation of an e-mail remittance advice to the supplier 120. The e-mail remittance advice is used to transmit to the supplier 120 partially masked purchasing card data, information about how much to charge the purchasing card, and a unique payment number generated by the buyer's ERP 110a. The unique payment number is associated by the buyer's ERP 110a with a corresponding open purchase order.

At step 465, the supplier submits the transaction for authorization and settlement. When the supplier 120 submits an authorization request for payment of its invoice via a POS terminal 130, the supplier 120 inputs the partially masked card details and the unique payment number provided in the remittance advice when prompted by the POS terminal 130. The supplier 120 may enter the unique payment number, for example, in the customer code field when prompted for it by the POS 130.

At step 470, the buyer 110 processes the issuer's 160 periodic, and preferably monthly, purchasing card transaction statement, which summarizes all the buyer's 110 purchasing card activity for a particular period. At step 470, the issuer's 160 purchasing card transaction data is preferably entered into the buyer's ERP 110a as a prepayment invoice, and paid when due. The buyer's ERP 110a creates and pays a prepayment invoice for the full amount of payment due to the card issuer 160. These payments are preferably posted to the internal bank account created at step 440.

At step 475, The purchasing card transaction statement is preferably imported as purchasing card transaction data into the buyer's ERP system 110a, from the data repository 170. The purchasing card transaction data may be transmitted from the data repository 170 to the buyer's ERP 110a as a text file via FTP. The data file may then be loaded into a database table in the buyer's ERP system 110a. The purchasing card transaction data details the buyer's 110 purchasing card transactions for the preceding period. In accordance with an embodiment of the present invention, the purchasing card transaction details include the unique payment number that was generated by the buyer's ERP 110a, and that was inputted to the POS by the supplier during the payment authorization process.

At step 480, the buyer's ERP 110a automatically validates and approves the purchasing card transactions. In an exemplary embodiment of the present invention, the buyer's ERP 110a validates the e-mail remittance advice's unique payment number, which was inputted into the POS 130 by the supplier 120, along with supplier name, supplier site, and amount match, and then updates each matched transaction to “Approved.” These transactions are preferably coded to the purchasing card internal clearing account used in the payment processing described above, thus offsetting the “payment.”

Finally, at step 490, the buyer's ERP 110a imports these approved transactions as invoices and applies them to the prepayment that it made to the purchasing card issuer at step 475.

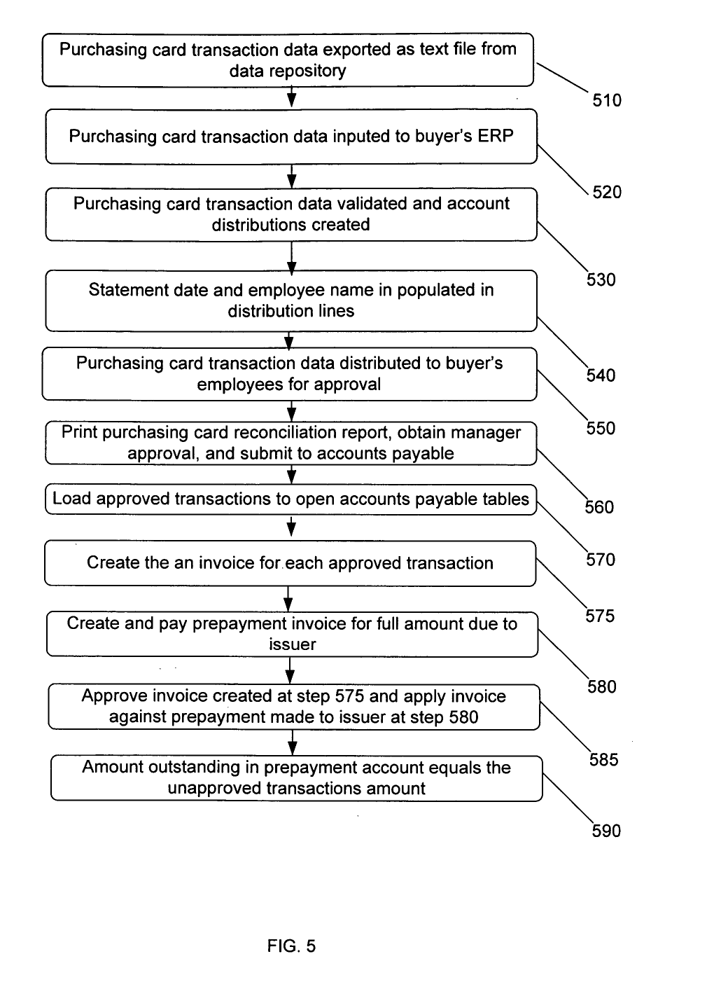

FIG. 5 is a flowchart depicting another exemplary process for using the buyer's ERP 110a to reconcile purchasing card transactions initiated by purchase order. At step 510, purchasing card transaction data is exported from the data repository 170 and inputted to the buyer's ERP 110a, as previously described.

At step 520, the buyer's ERP 110a loads the imported purchasing card transaction data is loaded to an open accounts payable database table, such as, for example, the AP_EXPENSE_FEED_LINES_ALL table. At step 530, the buyer's ERP 110a validates the purchasing card account numbers received with the purchasing card transaction data, and creates account distributions based on the buyer's 110 employees' profiles and merchant category codes.

At step 540, the buyer's ERP 110a populates statement date and employee name data in the account distribution lines. The populating step of step 540 preferably supports a requirement to have the “Bank Statement Date” and “Merchant Name” fields in the procurement card invoice number.

At step 550 the buyer's ERP 110a distributes purchasing card transactions data to the buyer's employees and prompts the employees approve their purchasing card transactions. At step 560, for those purchasing card transactions that are approved, the employees submit an approval notification to the buyer's ERP 110a. The employees are preferably able to split the amount of the transactions into two or more distribution lines and, in addition, are preferably able to change the account combination. There preferably also exists a comments field, that may be filled by employees prior to approval. At step 560, the employees may also print a purchasing card reconciliation report, obtain manager approval, and submit the reconciliation report to accounts payable.

At step 570, the buyer's ERP 110a loads the approved transactions to the open accounts payable database tables. At step 575, the buyer's ERP 110a creates an invoice for each approved and open transaction. At step 580, the buyer's ERP 110a creates and pays a prepayment invoice for the full amount of payment due to the card issuer 160. At step 585, the buyer's ERP 110a approves the invoice created at step 575 and applies it against any prepayment (see step 580) made to the card issuer 160. Finally, at step 590, any amount outstanding in the prepayment account will equal the unapproved transactions amount, details of which can be extracted using a custom report. Preferably, these transactions are also accrued at the end of the month.

In the exemplary processes described above, the following Oracle® tables may be used in accordance with the present invention:

| # | Table Name | Description |
|---|---|---|
| 1 | AP_EXPENSE_FEED_LINES_ALL | Table to load P-Card |
| | | Transactions |
| 2 | AP_EXPENSE_FEED_LINES_ALL | Expense Account |
| | | combinations for the |
| | | P-Card transactions |
| | | populated in this table |
| 3 | AP_CARDS_ALL | Table holding Credit |
| | | Card Details |
| 4 | AP_CARDS_CODES_ALL | Table holding MCCs |
| 5 | AP_CARDS_PROFILES_ALL | Table holding Card |
| | | profile details |
| 6 | AP_CARDS_PROGRAMS_ALL | Table holding Card |
| | | program detail |
| 7 | AP_INVOICES_INTERFACE | Open Interface table |
| | | to which approved |
| | | transaction header |
| | | lines are transferred |
| 8 | AP_INVOICE_LINES_INTERFACE | Open Interface table |
| | | to which approved |
| | | transaction distribution |
| | | lines are transferred |
| 9 | AP_INVOICES_ALL | Table holding invoice |
| | | header information |
| 10 | AP_INVOICE_DISTRIBUTIONS_ALL | Table holding expense |
| | | account information of |
| | | invoice |

We claim:

1. A method for using an enterprise resource planning (ERP) system to automate reconciliation of transactions between a buyer and a supplier made using a purchasing card, the method comprising:
receiving an invoice from the supplier, the invoice being associated with an open purchase order;
generating, using the ERP, a unique number associated with the open purchase order;
sending to the supplier a remittance advice associated with the supplier's invoice, the remittance advice including the ERP-generated unique number;
receiving purchasing card transaction data, the transaction data including the ERP-generated unique number; and
matching the ERP-generated unique number to the associated open purchase order to approve the transaction.

2. The method according to claim 1, further comprising:
generating a prepayment invoice for the full amount of the supplier's invoice;
paying the prepayment invoice; and
posting the prepayment to an internal account.

3. The method according to claim 2, further comprising:
applying an amount of the approved transaction to the prepayment amount.

4. The method according to claim 3, wherein the purchasing card transaction data is transmitted from a data repository to the ERP.

5. The method according to claim 4, wherein the sending step comprises e-mailing the remittance advice to the supplier.
